(19) United States
(12) Patent Application Publication
(10) Pub. No.: US 2009/0258279 A1
(43) Pub. Date: Oct. 15, 2009

(54) FUEL CELL SYSTEM, IN PARTICULAR, FOR USE ON BOARD A COMMERCIAL AIRCRAFT OR MOTOR VEHICLE

(75) Inventors: Ronny Knepple, Uberlingen (DE); Dieter Blumenstein, Uhldingen-Muhlhofen (DE); Bernd Speth, Uberlingen (DE)

Correspondence Address: SCULLY SCOTT MURPHY & PRESSER, PC, 400 GARDEN CITY PLAZA, SUITE 300, GARDEN CITY, NY, 11530, US

(73) Assignee: DIEHL AEROSPACE GMBH, Uberlingen (DE)

(21) Appl. No.: 12/392,166

(22) Filed: Feb. 25, 2009

(30) Foreign Application Priority Data
Apr. 15, 2008 (DE) 10 2008018779.8

(51) Int. Cl. H01M 8/04

(52) U.S. Cl. 429/34

(57) ABSTRACT

For operation on board a commercial aircraft (11) or motor vehicle, a fuel cell (12) together with its educt fittings (13H, 13O) is operated in the air cushion (14) of a pressure-tight enclosing housing (15) in order to prevent hydrogen (H) possibly still issuing from leaks (16) against that increased pressure to form at the environmentally-explosive oxyhydrogen gas, but to be able also to feed it, heated to promote reaction by the waste heat of the cell (12) itself, to the cell (12), together with operating air (17) taken from the air cushion (14).

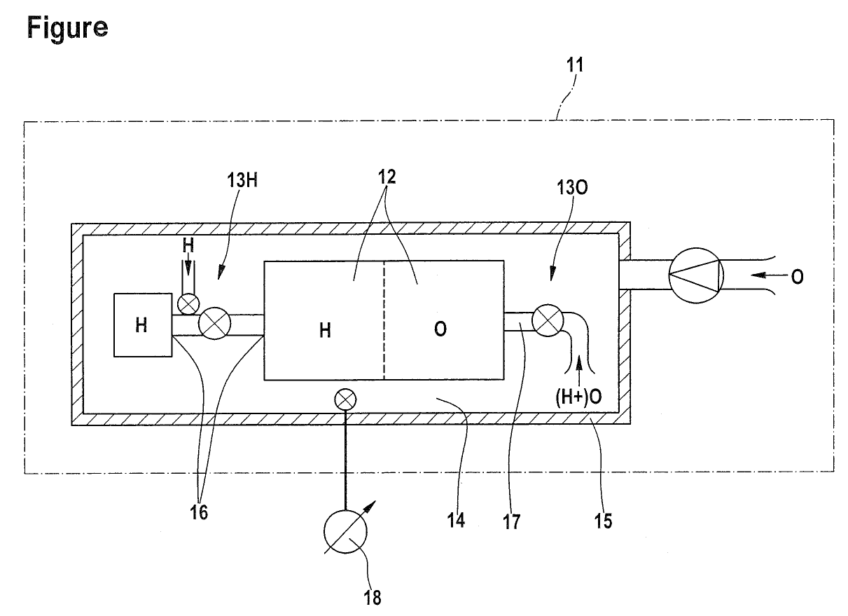

### BACKGROUND OF THE INVENTION

1. Field of the Invention

The invention concerns a fuel cell system, which, in particular, is used on board a commercial aircraft or motor vehicle.

2. Discussion of the Prior Art

Energy supply units with fuel cells for use in commercial aircraft are described, for example, in German Patent Publication DE 10 2005 054 883 A1. They serve there for recharging current and water storage devices in movable automatic beverage dispensing units for use in the cabin. In the course of recharging the electrical accumulator in the automatic beverage dispensing unit the hot water which is produced as a reaction product in the fuel cell is also decanted for dissolving or brewing beverages. A plurality of such energy supply units can be installed in various regions of the aircraft, in particular in the front and rear on-board kitchens and in the central region of the passenger cabin in order there to be started up in the course of providing food and drink for the passengers for recharging the automatic beverage dispensing units.

German Patent Publication DE 10 2006 002 470 A1 describes various aspects which indicate the interest in the use of reaction products from operation of electrolysis devices which are operated with fuel cells on board commercial aircraft. That includes the use of the water produced as service and also utility water in order not to burden the take-off procedure with water supplies carried on board, or adding an increased oxygen content to the cabin air in order to manage with a lower internal pressure while in flight and thereby to reduce the structural loading on the aircraft structure resulting from the difference in relation to the ambient pressure at the flight altitude.

On the other hand the operation of a fuel cell system involves an increased risk potential precisely in a self-contained system such as an aircraft frame as hydrogen issuing from the cell or its fittings on the one hand is difficult to detect and on the other hand forms explosive oxyhydrogen gas with the ambient air, for which reason the system must shut down immediately upon the occurrence of leaks. In addition to that problematical safety aspect there is the detrimental economic aspect that, in the interests of a favourable degree of efficiency, a fuel cell should be operated with the lowest possible level of power modulation, for which reason the pressure and temperature fluctuations which inevitably occur on board an aircraft in the different phases of flight (and which are usually not checked at all by a regulating procedure outside the passenger cabin, for example in the cargo hold) have a negative effect on the operating characteristics of the fuel cell.

### SUMMARY OF THE INVENTION

In consideration of such factors the technical object of the present invention is to increase the acceptance and breadth of use of fuel cell systems of the general kind set forth by measures for promoting operational safety and economy.

According to the invention that object is attained in that the fuel cell is surrounded by a pressure-tight enclosing housing which moreover is filled with air which is under an increased pressure relative to the reaction chamber of the fuel cell and is preferably fed to the fuel cell itself as one of its two operating or educt gases.

In the event of a leak occurring at the fuel cell or upstream thereof, at the feed-in fitting or at the hydrogen generator or tank, the increased pressure of the enclosing air cushion counteracts the escape of hydrogen. In particular however the escaping volume—which in any case is correspondingly reduced as a consequence of the counteracting pressure—cannot adversely affect the environment on board the aircraft, but it remains enclosed in the housing.

The amount of hydrogen leakage is not lost for the cell if the hydrogen which has issued into the air cushion is fed together with air from the cushion to the cell as its second educt gas, in which case the hydrogen catalytically reacts with the oxygen in the air to give water, with the delivery of heat. The reaction heat which occurs in operation of the fuel cell and which is discharged therefrom into the ambient air cushion also remains in the system insofar as the operating air is taken from the air cushion which is thus heated by the cell itself.

In contrast, larger leakage amounts would collect in the upper region of the enclosing housing where they can be more easily detected and from where they can be specifically removed and fed to the system separately from the operating air.

The air cushion also affords a certain decoupling of the operation of the cell from interfering environmental influences such as major temperature or short-term pressure fluctuations which occur in in-flight operation, if the fuel cell is operating in the aircraft cargo hold which is not air-conditioned. On the other hand the leaks are easier to track if for maintenance operations the air cushion of the cell environment is let out of the enclosing housing.

As the intermediate spaces structurally afforded between the fittings and other components involved in the technology of the installation are available for the volume of the air cushion, the enclosing housing does not need to entail any volume which goes substantially beyond the installation space requirement for the fuel cell system overall, in order at the same time to represent a compressor-inlet pressure container. In addition, by virtue of its arrangement in the increased pressure of the air cushion within the hermetically sealed enclosing housing, there is no longer any need for a double-wall conduit for the hydrogen, and that additionally reduces the amount of space required for the overall system. On the other hand, in the interests of optimised operating parameters, the volume of the air cushion, which is comparatively small as a result, can implement environmental pressure and temperature regulation of the fuel cell, quite without any problem.

### BRIEF DESCRIPTION OF THE DRAWING

The fuel cell system designed according to the invention is shown in greater detail by means of the drawing. The single FIGURE thereof shows the installation of the cell and its operating fittings in an enclosing housing in a form of being abstracted to what is functionally essential and on a greatly reduced scale.

### DETAILED DESCRIPTION OF THE INVENTION

In accordance with the invention therefore a system comprising a fuel cell 12 and its educt fittings 13H, 13O, intended in particular for use on board a commercial aircraft 11, is operated in the air cushion 14 in the interior of a pressure-tight enclosing housing 15. In that way the hydrogen H which is stored or generated for operation of the cell 12 in the enclosing housing 15 and which issues from any leaks 16 cannot lead to explosive oxyhydrogen gas at the environment, but it remains enclosed in the air cushion 14 of the housing 15 without giving rise to interruptions in operation. Those leakage amounts then even also pass into the fuel cell 12, with operating air (H+)O=17 taken from the air cushion 14. The air cushion 14 is heated to promote reaction in the housing 15 by the waste heat from operation of the cell and can be additionally subjected to pressure or temperature regulation 18.

What is claimed is:

1. A fuel cell system, in particular for use on board a commercial aircraft (11) or motor vehicle, comprising a fuel cell (12) connected to a storage means or to a gas generator and to fittings (13H, 13O) for first and second educt gases hydrogen (H) and oxygen (O), such as air, wherein said fuel cell is operably arranged under the increased pressure of an air cushion (14) within a pressure-tight enclosing housing (15) which is resistant to environmental influences.

2. A fuel cell system according to claim 1, wherein the fuel cell (12) is fed with the second educt gas (O) from the air cushion (14).

3. A fuel cell system according to claim 1, wherein there is provided a pressure and/or temperature regulation (18) for the air cushion (14).

4. A fuel cell according to claim 1, wherein leakage hydrogen withdrawn from an upper region of the enclosing housing (15) is fed to the fuel cell (12).
